(19) United States
(12) Patent Application Publication
(10) Pub. No.: US 2008/0115788 A1
(43) Pub. Date: May 22, 2008

(54) Ventilator mask attachment device with straps

(76) Inventors: Simone Eschen, Hamburg (DE); Martin Bechtel, Winsen/Luhe (DE)

Correspondence Address: FRIEDRICH KUEFFNER, 317 MADISON AVENUE, SUITE 910, NEW YORK, NY, 10017, US

(21) Appl. No.: 11/977,741

(22) Filed: Oct. 24, 2007

(30) Foreign Application Priority Data
Oct. 24, 2006 (DE) 10 2006 050 725.8

(51) Int. Cl. A62B 18/08

(52) U.S. Cl. 128/207.11; 128/206.27

(57) ABSTRACT

An attachment device for fastening a ventilator mask on the head of a wearer includes a system of straps with at least two strap ends with a fastening device for fastening the straps to the ventilator mask. The straps are joined with a central section, so that at least two strap ends extend away from the central section towards the ventilator mask. The central section rests on the head of the wearer and is at least partially adapted to the shape of the wearer's head. In addition, a method for producing the attachment device includes subjecting the central section to a performing step to adapt it to the shape of the wearer's head.

### BACKGROUND OF THE INVENTION

1. Field of the Invention

The present invention relates to an attachment device with straps for holding a ventilator mask on the head of a user.

2. Description of the Related Art

Attachment devices for ventilator masks are known in the art. In particular, head covering devices are known in a variety of embodiments. They consist of straps that are brought together at the neck and are joined with the mask in such a way that they are fastened to the mask at three points. In this regard, the main concern is especially proper seating of the mask, which is often achieved at the expense of the comfort of the patient. A mask of this type is described in DE 101 58 066.

Also well known are ventilator masks or head masks that essentially surround the chin region in much the same manner as, for example, equestrian riding helmets. The ear and cheek region of the wearer is relieved with this type of design. A ventilator mask that is fastened in this way is described in DE 103 38 169 A1.

The head mask fastening devices or attachment devices known from the prior art are essentially fabricated in such a way that their fit is based on the joining of individual, two-dimensional parts. Weld seams, gluing seams, or other types of seams that result from this joining can be elevated and thus cause irritation or pressure points on the contact surfaces or on points on the head of the wearer.

### SUMMARY OF THE INVENTION

Proceeding from this prior art, the object of the present invention is to create an attachment device for ventilator masks that is improved with respect to individual physiognomic and functional adaptability.

In accordance with the invention, this object is met by virtue of the fact that the straps are joined with a central section, where at least two strap ends extend away from the central section towards the ventilator mask, and where the central section rests on the head of the wearer and is at least partially adapted to the shape of the wearer's head.

A further object of the present invention is to improve a method for producing an attachment device for fastening a ventilator mask on the head of a wearer in such a way that an attachment device is produced which visually indicates correct placement of the ventilator mask on the head of the wearer. In accordance with the invention, this object is met by virtue of the fact that the ventilator mask is provided with a central section and a system of straps with at least two strap ends, wherein at least two of the strap ends extend away from the central section towards the ventilator mask, the straps are joined with the central section which rests on the head of the wearer, and the central section is preformed, so that it is at least partially adapted to the shape of the wearer's head.

The invention concerns an attachment device for fastening a ventilator mask on the head of a wearer. It includes a central section, which rests, for example, against the back of the wearer's head when the wearer is using the mask, and a system of straps that is joined with the central section. This system of straps holds the ventilator mask by virtue of the fact that the ends of the straps are joined with the mask. The central section is preformed and adapted to the shape of the back of the wearer's head, so that an optimum fit of the attachment device is obtained. As a result of the large contact surface area of the central section, tensile forces that are exerted by the straps and the mask on the head of the wearer are optimally absorbed. Alternatively or additionally to the placement on the back of the head, placement on the chin is also possible. In this case, the central section is adapted to the shape of the chin.

One specific embodiment of the invention concerns the preformed central section, which is made of a textile fabric that is soft and comfortable and pleasant to wear on the scalp and facial skin and at the same time is suitable for being permanently adapted to the shape of the wearer's head by performing. An advantageous aspect of this is that individual attachment devices are obtained. The shape of the central section can be individually adapted to the shape of the wearer's head. Once its has been thermally preformed, the central section permanently retains the desired geometry and yet keeps its flexibility, since the straps can be variably adjusted. This provides the advantage that the mask can be worn pleasantly and comfortably.

In another specific embodiment, the device is made from a single tubular piece of textile that has likewise been permanently thermally preformed, so that seams and joints in the area of the back of the head and on the cheeks and temples of the wearer are completely avoided, which offers the advantage that wearing the mask does not produce any pressure points or friction points on the head of the wearer.

In addition, some specific embodiments of the invention pertain to an attachment device produced from several parts, such that the various parts of the attachment device are operatively connected with one another in such a way that different fits are produced. The attachment device produced in this way has the advantage of great flexibility. Either the attachment device can be adapted to several wearers, or one and the same wearer can optimally adapt the attachment device to his individual physiognomy according to his varying situation.

In accordance with another specific embodiment of the invention, the attachment device has a central section with a recess that constitutes a basic geometric form. Alternatively, a basic geometric form can be mounted or applied here in the vicinity of the attachment device. This then also serves as a tensile force indicator. This results in the advantage that when tensile force is applied, this basic geometric form is deformed in such a way that the deformation can be used as a measure of the applied tensile force. If too much tensile force is applied, the basic geometric form is deformed, which induces the wearer to loosen the straps in such a way that the deformation is reversed until, ideally, the original basic geometric form is restored.

Other embodiments of the invention concern methods for producing the above-described attachment device of the invention. One method in accordance with the invention concerns the fabrication of the attachment device from a single part. This offers the advantage of a seamless or almost seamless attachment device.

Another method in accordance with the invention concerns the production of the attachment device with the use of a thermal performing process or molding. This has the advantage that the section of the attachment device produced by means of molding maintains the permanently preformed geometry. Methods in accordance with the invention include the individual measurement of a wearer's head.

Further embodiments of the invention and some of the advantages associated with these and other embodiments are clarified and made more understandable by the following detailed description and the accompanying drawings. Objects or parts illustrated in the drawings that are essentially the same or very similar are provided with the same reference numbers.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a three-dimensional view of a helmet-shaped attachment device with four strap ends, each of which is joined with itself to form a loop.

FIG. 2 shows the helmet-shaped attachment device of FIG. 1, in which two of the strap ends are not joined with themselves.

FIG. 3 is a three-dimensional view of an attachment device with a basically triangular structure and with three strap ends.

FIG. 4a is a three-dimensional view of an attachment device that is produced as a single piece from a tubular section and has one recess.

FIG. 4b is a three-dimensional view of an attachment device that is produced as a single piece from a tubular section and has two recesses.

FIG. 4c shows an alternative embodiment of the three-dimensionally illustrated, single-piece attachment device from FIG. 4b.

FIG. 4d is the three-dimensional view of an attachment device that is produced as a single piece from a tubular section, wherein four strap ends are produced by cutting vertically through an upper transverse web and a lower transverse web.

FIG. 5a is a side view of a wearer with the attachment device in place.

FIG. 5b is a three-dimensional view of a wearer with both the ventilator mask and attachment device in place.

FIG. 6a is a schematic front view of a two-part attachment device arranged in such a way that four strap ends are made available for securing the ventilator mask.

FIG. 6b shows the attachment device of FIG. 6a arranged in such a way that three strap ends are made available for securing the ventilator mask.

FIG. 7 is a perspective top view of an attachment device produced from two parts, where the preformed central section (see FIG. 7c) is obtained only after the part shown in FIG. 7a has been joined with the part shown in FIG. 7b.

FIG. 8 is a top view of an attachment device produced from two symmetric blanks, where FIG. 8a shows a first geometry and FIG. 8b a second geometry.

FIG. 8c is a top view of an attachment device produced from two symmetric blanks and an inserted middle section.

FIG. 9a is a top view of a blank for producing an attachment device with four strap ends, and FIG. 9b shows the top view of an attachment device with four strap ends, which was produced from two blanks of the type shown in FIG. 9a.

FIG. 9c shows an alternative geometry from that of the attachment device shown in FIG. 9d.

FIG. 9d is a schematic top view of an attachment device produced from two symmetric blanks, wherein the blanks are joined with each other by a lace.

FIG. 10a is a schematic top view of a blank and a central section for forming an attachment device.

FIG. 10b is a top view of the attachment device produced from two symmetric blanks and a central section according to FIG. 10d, with the two symmetric blanks joined by the central section.

FIG. 10c shows a blank and a central section for forming an attachment device.

FIG. 10d is a top view of the attachment device produced from two symmetric blanks and a central section according to FIG. 10c.

FIG. 10e shows a blank and a central section for forming an attachment device.

FIG. 10f is a top view of the attachment device produced from two symmetric blanks and a central section according to FIG. 10e.

FIG. 11 shows various embodiments of a one-piece attachment device with four strap ends, wherein FIG. 11a has crescent-shaped recesses in the central section thereof; FIG. 11b has a strip-like central section inserted between two strap elements; FIG. 11c shows a one-piece attachment device with three oval recesses in the central section; FIG. 11d shows a one-piece attachment device with four strap ends; FIG. 11e shows a one-piece attachment device with four strap ends and a more or less rectangular recess in the central section; FIG. 11f shows an attachment device produced from two parts with four strap ends produced from one strap with a convex cut and one strap with a concave cut; FIG. 11g shows the attachment device according to FIG. 11f, wherein the concave form from FIG. 11f contains an oval opening; and FIG. 11h shows a geometric alternative to the concave geometry of FIG. 11g.

FIG. 12 is a top view of a fastening device for joining the strap ends with the ventilator mask. The fastening device is composed of two parts. FIG. 12a shows the two parts separated from each other, FIG. 12b shows the two parts engaged with each other, and FIG. 12c shows a fastening device that is a shorter alternative to the fastening device of FIG. 12b.

### DESCRIPTION OF THE PREFERRED EMBODIMENTS

The explanations which follow shall define the terms used in the specification and the claims.

A “ventilator mask” is a ventilating device for supplying respiratory gas via the nose and/or mouth. The ventilator mask can be designed accordingly as a full mask or as a partial mask, which covers only the nose and is designated a nasal mask.

An “attachment device” is a device that serves to position and secure the ventilator mask on the face of the user. One of the functional properties of the attachment device is that it makes it possible to secure the mask on the face with a sufficiently tight seal that gas flowing into or out of the mask does not escape to the outside through the sealing edge of the mask but rather flows in and out only through the gas supply and gas discharge devices provided for this purpose.

The “central section” of an attachment device of the invention is defined as the area of the attachment device that rests against the back of the wearer's head. It can extend over several parts that form the attachment device and can have different shapes and sizes.

A “preform” is a workpiece on which a shaping technique is used to impress a permanently retained three-dimensional geometry on the initially two-dimensional workpiece. Well-known shaping techniques include especially thermal shaping techniques, such as the hot-pressing method or molding. It lends permanent dimensional stability to the workpiece.

A “tensile force indicator” is a visual indicator function that makes it clear how much force is acting on the attachment device at the back of the head.

The specific embodiments of the present invention involve, for example, attachment devices with which the ventilator masks, such as masks for CPAP therapy (continuous positive airway pressure therapy) for the treatment of apnea, can be fastened on the head.

All of the attachment devices of the invention have a system of straps with at least two, but usually more than two, strap ends, with which the ventilator mask can be securely placed on the head of the wearer by three-point, four-point, or five-point fastening. The attachment device basically has a central section, which is joined with a system of straps in such a way that the ends of the straps are directed away from the central section, which rests on the head of the wearer, and towards the ventilator mask. The central section has a key position, because the tensile forces arising from the mask become focused in the central section. Therefore, it is at least partially adapted to the shape of the wearer's head, so that the best possible fit of the attachment device is obtained, and thus the ventilator mask can develop full functionality but without being felt as uncomfortable while being worn for long overnight periods and without causing friction points. The central section that rests on the head of the wearer can have different sizes in different embodiments.

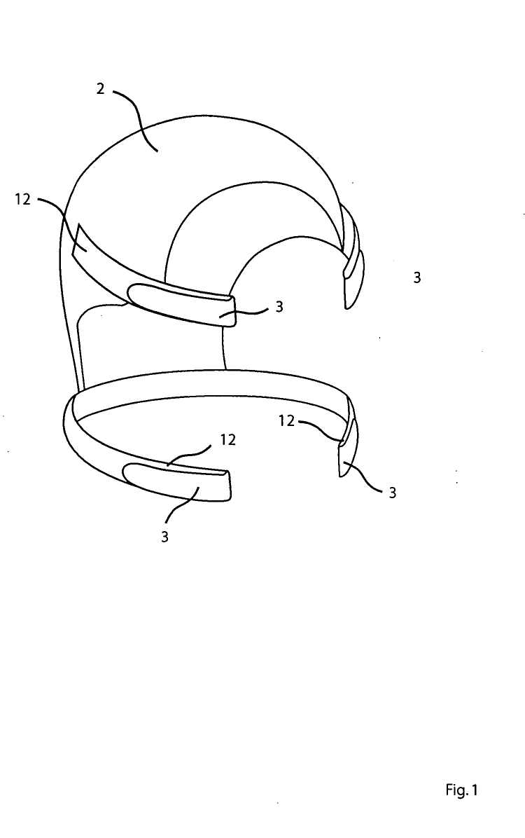

FIG. 1 shows an attachment device in which the central section is shaped like a helmet. It protectively covers the back of the head up to the forehead and at the neck. At the level of the forehead and at the base of the neck section, four strap ends 3 of the system of straps extend away from the central section 2 and towards the ventilator mask, not shown in the drawing.

The attachment device illustrated in FIG. 1 is constructed of four parts: A first part is the central section 2, which is a preform that is adapted to the physiognomy of the back of the head. The second part is a strap that is attached to the edge of the neck portion of the central section 2. This strap is of such a length that it extends from the neck to the chin on both sides. Each of the two ends 3 of this strap is joined with itself to form a loop 12.

Straps—parts three and four—with strap ends 3 are attached to the areas of the central section 2 near the temples. Each of these strap ends 3 is also joined with itself to form a loop 12. There are a total four loops 12. They are provided for the purpose of holding corresponding fastening devices on the ends of the straps or directly on the ventilator mask.

The strap material in the present case is sewn onto the central section 2. It also functions as a friction fastener, so that when the strap ends are passed through a fastening device, e.g., an eye, provided on the ventilator mask, and are then bent backwards, a friction joint is produced. The ventilator mask is thus secured in its position on the wearer's face.

Due to the large contact surface area between the central section 2 and the back of the head, the attachment device comes to rest smoothly against the head without any pressure points. The straps fastened to the central section 2 are made of soft textile material. They absorb the tension of the mask without provoking pressure points and friction.

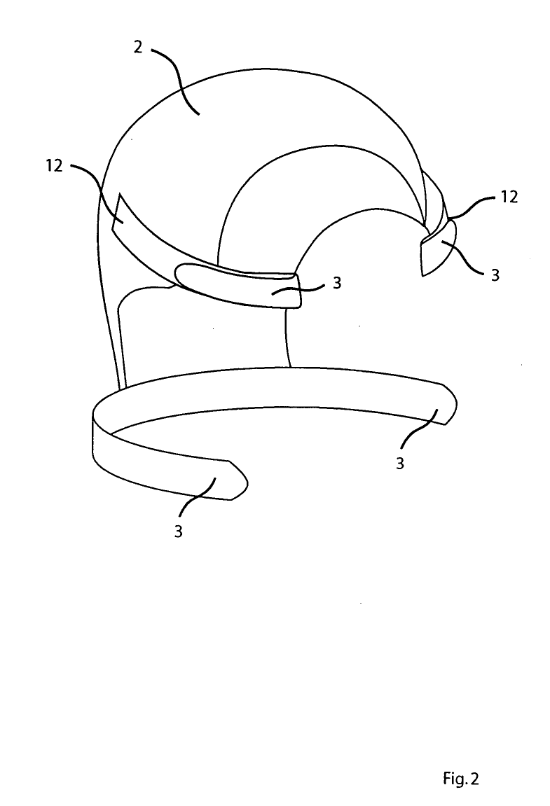

FIG. 2 shows the attachment device with the three-dimensional, preformed central section 2, whereby the strap ends 3 that are located at chin level are opened.

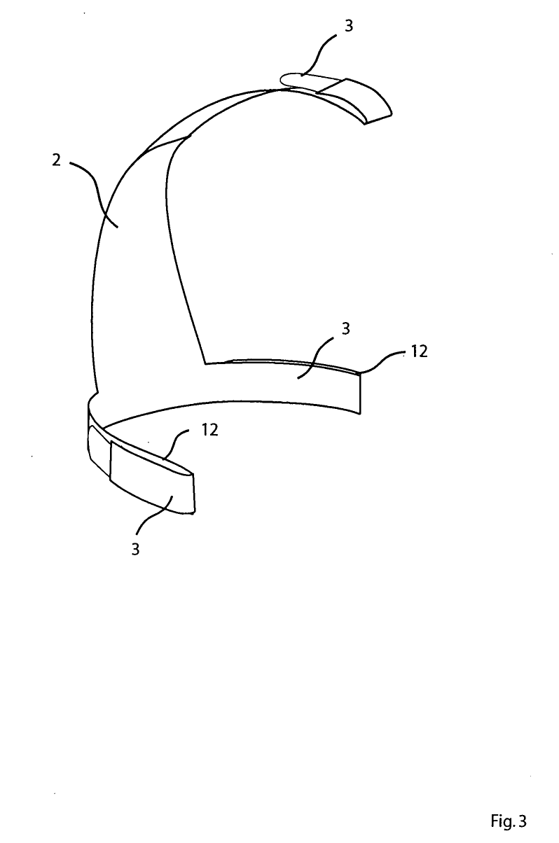

The attachment device shown in FIG. 3 has a basically triangular structure. It likewise has a three-dimensionally preformed central section 2, which fits against the neck region of the back of the head in the full width of the head of the wearer but tapers towards the forehead, so that only one strap end 3 extends from the middle of the forehead to the nasal region of the ventilator mask. As shown in FIGS. 1 and 2, each strap end 3 is joined with itself to form a loop 12, which, when the mask is being worn, is engaged by a corresponding eye (not shown in FIG. 3) present on the ventilator mask.

The strap ends shown in FIGS. 1, 2, and 3 are joined with themselves by friction fasteners, but other suitable fastening means are possible. For example, snap fasteners, button-buttonhole fasteners, or other suitable fasteners can be used for releasable joining of the strap ends 3 with themselves. Releasable joining of the fastening device with the ventilator mask is advantageous especially because it allows a wide variety of attachment devices to be secured on the ventilator mask, for example, if the attachment device presently being used needs to be washed.

In principle, the fastening devices of the attachment device can comprise more than one part. In this case, one part, for example, a clip or hook, can be engaged by the loop and remain there, while a second part, i.e., the counterpart of the clip or hook, is located on the mask. To secure the mask on the face, it is then merely necessary to join the first parts with the corresponding second parts.

The attachment devices of the invention can be made of textile material. The textile materials can be natural or synthetic fabrics or mixtures of the two. Finally, it is also possible for the attachment device to consist wholly or partly of natural or synthetic elastomers. Thus, it is possible, for example, for the central section, which fits against the back of the head, to be made of a washable natural textile, while the system of straps that rests against the chin or forehead can be made of a plastic or polymer, which, advantageously, can be easily cleaned by quickly wiping it. This has been found to be advantageous especially because nighttime sweating or salivation do not then make it necessary to wash the whole attachment device.

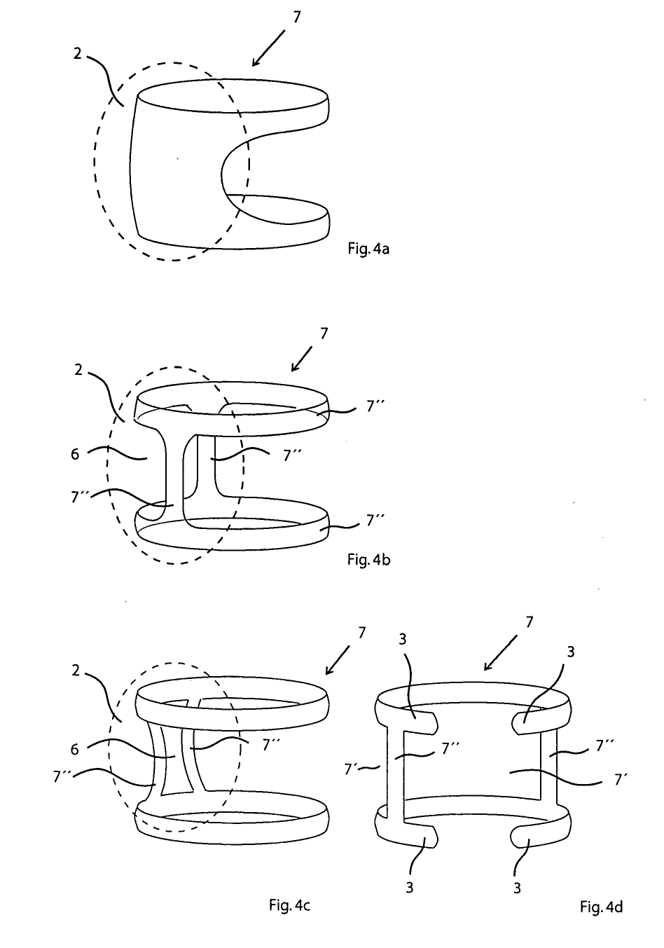

FIG. 4 shows an attachment device of the invention produced from a single part, which in the present case is a tubular section 7 of textile material. The attachment device is produced by carrying out successive steps for removing sections from the tubular structure. Depending on the material of which the tubular structure is made, the removal process is carried out by cutting or severing the material. FIG. 4a shows an attachment device in which a recess 7′ was removed from the tubular section only in the facial region.

In the present case, the recess 7′ has the shape of a large ellipse that extends from one ear to the other and exposes the area from the forehead to the chin. A transverse web of material is left at the level of the chin and at the level of the forehead. If the transverse webs are cut vertically, four strap ends 3 are obtained, as illustrated, for example, in the embodiment shown in FIG. 4d.

The attachment device shown in FIG. 4d, in contrast to the one shown in FIG. 4a, has an additional recess 7′ in the tubular section in the area of the back of the head, so that only two vertical webs 7″ still connect the two transverse webs 7″ left at the forehead level and chin level with each other. The attachment devices shown in FIGS. 4b and 4c are similarly constructed and differ only by the shape and size of the recess 7′. The recess 7′ that comes to rest at the back of the head is thus an opening 6 in the central section 2 (indicated by a broken line in FIGS. 4b and 4c), which partially exposes the back of the head, which can be advantageous for individuals who sweat heavily in the head region.

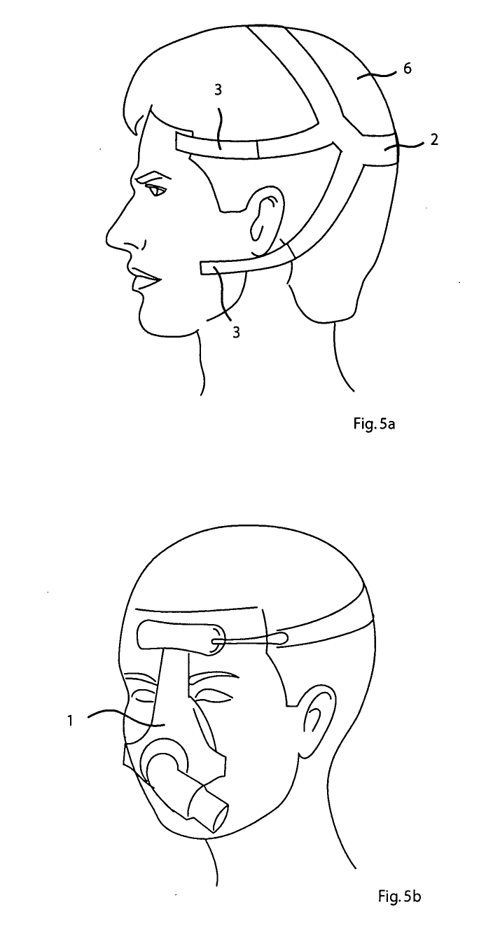

The attachment devices shown in FIGS. 4a to 4d have the advantage that there are absolutely no seams, so that the attachment devices rest perfectly smoothly and without any problems on the skin of the wearer. The attachment device illustrated in FIG. 4d is worn by the wearer as shown in FIG. 5a. The central section 2 has a large central section opening 6, which is advantageous especially if the wearer has a very full head of hair or has a strong tendency to sweat. FIG. 5b shows the ventilator mask 1 on the face of the wearer. It is held is place by an attachment device in accordance with the invention.

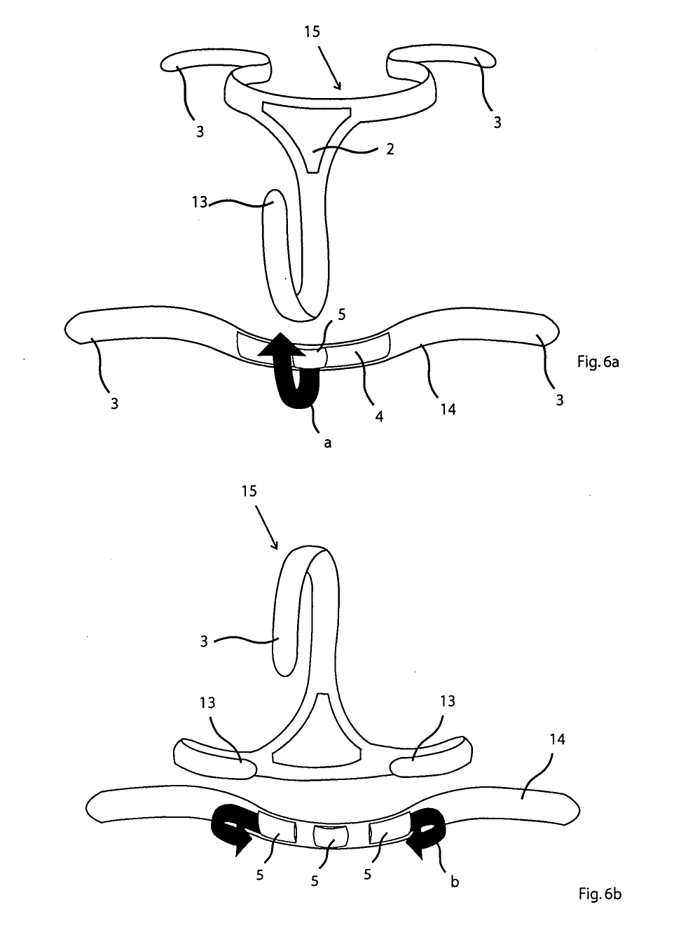

The attachment device of the invention can be constructed with two parts or multiple parts. FIGS. 6a and 6b show a two-part embodiment. This specific embodiment comprises a first part 14, which consists essentially of a strap onto which a receiving device 4 is sewn in such a way that three strap loops 5 are formed. A second part 15 comprises a central section 2 with three strap ends 3, 13 that extend away from the central section 2.

The connection between the two parts 14 and 15 is produced by passing the strap end 13 of the first part 15 through the strap loop 5 of the second part 14, as indicated by arrow a in FIG. 6a. The strap end 13 is pulled through the strap loop 5 to the desired length and then folded back and attached to itself. In the present case, the strap end 13 is furnished with a friction fastener that allows the strap to be joined with itself.

The joining of the parts 15 and 14 results in an attachment device with four strap ends 3, which can be passed through eyes provided on the ventilator mask in order to secure the ventilator mask on the face of the wearer. Instead of direct fastening to the mask by means of eyes, the two-part or multiple-part systems described above, such as clips, can be used. How far the strap ends are pulled through the associated eyes can be flexibly designed. This has the advantage that the wearer of the ventilator mask can adapt the mask to his physiognomy to ensure comfortable and functional seating of the mask during the night.

The illustrated combination of two parts can be used modularly, as is apparent from FIG. 6b. The part 15 can be used in a different application in such a way that the two ends 13 of part 15 are passed through the other two strap loops 5 of part 14 and folded back towards the inside, as indicated by arrow b, to produce releasable joining of part 15 with part 14. This leaves one free strap end 3 of part 15 and the two free strap ends 3, so that the attachment device provides three-point attachment. Other specific embodiments with parts that have an odd number of strap ends for producing an attachment device are conceivable.

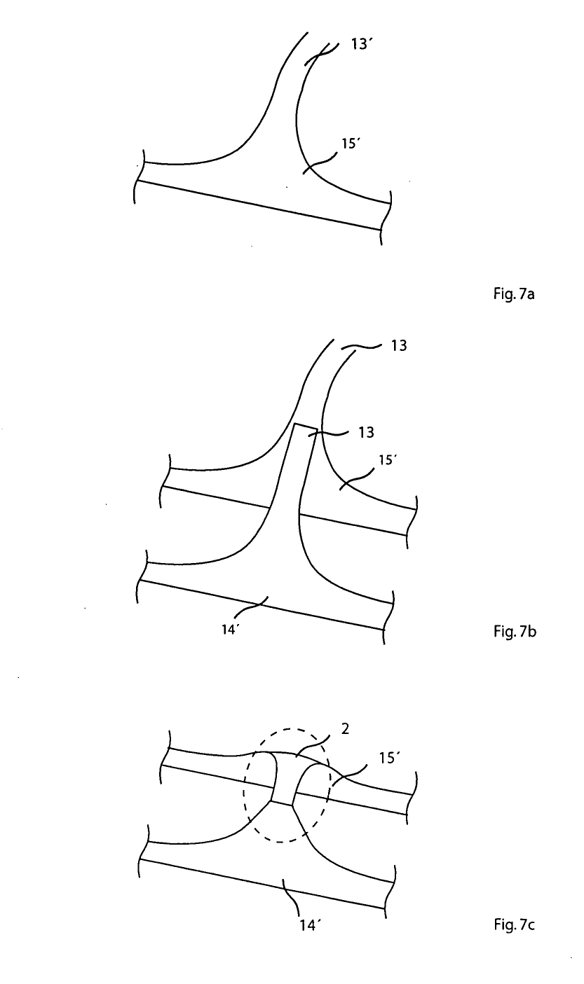

FIGS. 7a to 7c also show an attachment device produced from two parts. FIG. 7c shows a top view of the preformed central section 2 (indicated by a broken line), which fits against the back of the head. The central section 2 is produced by joining the second part 15′, which is shown in FIG. 7a and has the strap end 13, with the second part 14′, which has a second strap end 13. The molded part is thus located in the second part 15′, which is joined to part 14′.

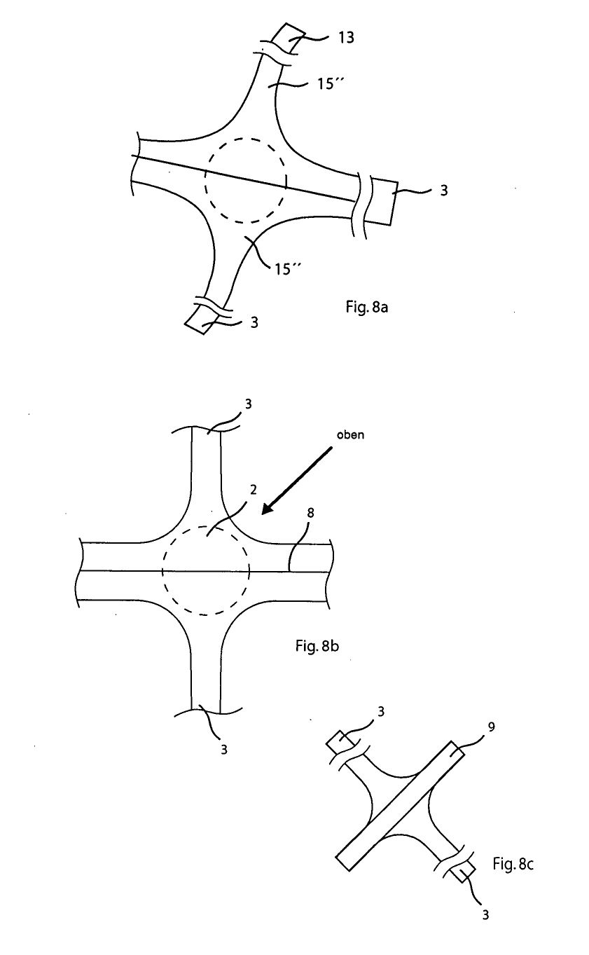

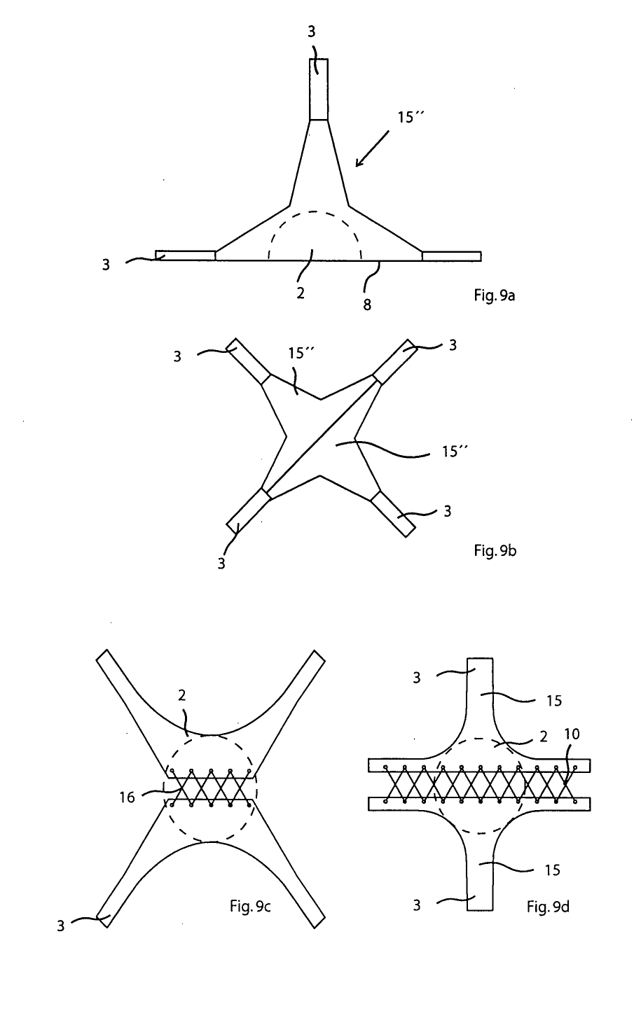

FIGS. 8a to 9e also show attachment devices that consist basically of two or three parts. The attachment device illustrated in FIG. 8a is produced from two identical blanks 15″, which are shaped approximately like the letter T. The parts 15″ are preformed at the place where the vertical section of the “T” and the horizontal section of the “T” meet. The two parts are joined along the horizontal section of the “T” by a friction fastener, so that the two partial preforms of the joined parts supplement each other to form a geometry that is adapted to the shape of the back of the wearer's head.

The embodiment shown in FIG. 8b is similar in geometry to the embodiment shown in FIG. 8a. The parts used in FIG. 8b can be produced by a simple stamping operation, which makes the production of these parts especially simple and economical. The parts shown in FIG. 8c have an equally simple geometric structure, and in this case, a center strap 9 is inserted along the center line 8. The choice of the center strap 9 can be advantageously based on whether the back of the head to be covered is larger or smaller. The center strap 9 is then made wider or narrower accordingly.

The parts used in FIGS. 9a to 9c are also blanks 15″ that are simple to produce. In each case, two parts with the centrally located central section 2 that contains the preformed region supplement each other to form an attachment device.

In principle, the blanks 15″ can also be produced by die cutting or other methods.

The parts for producing the attachment devices according to FIGS. 8a to 9b are joined with each other by friction fasteners, adhesive bonding, or sewing. However, in the specific embodiments shown in FIGS. 9c and 9d, the parts are joined by laces. Especially when the elastic lace 10 is used, this results in flexible placement of the central section 2 on the back of the head. This can prove to be an advantage especially if the wearer makes intense chewing or snoring movements while sleeping that cause corresponding movements of the jaw or the back of the head, which require that the mask be elastically mounted to guarantee its functionality.

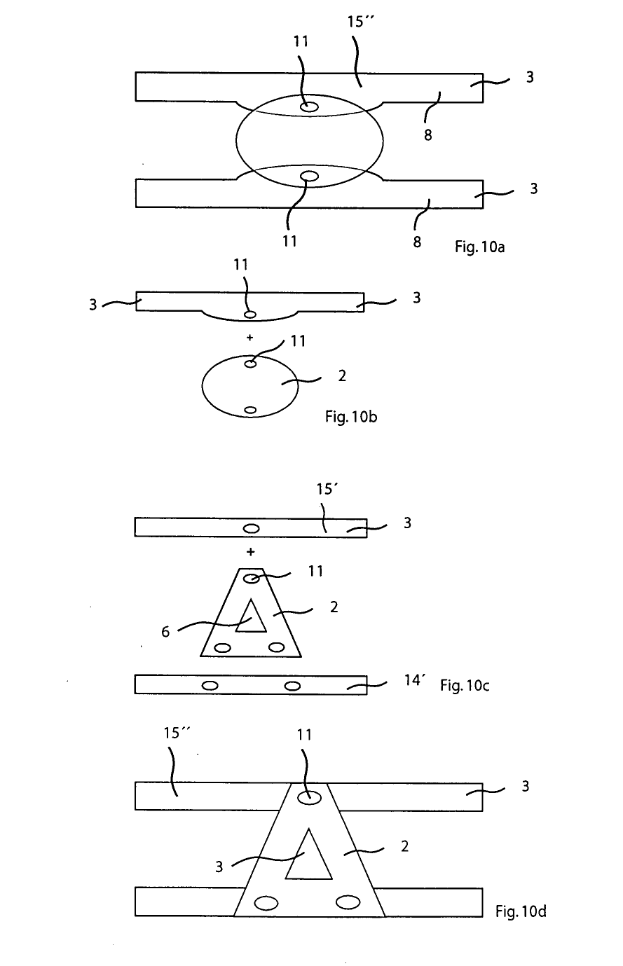

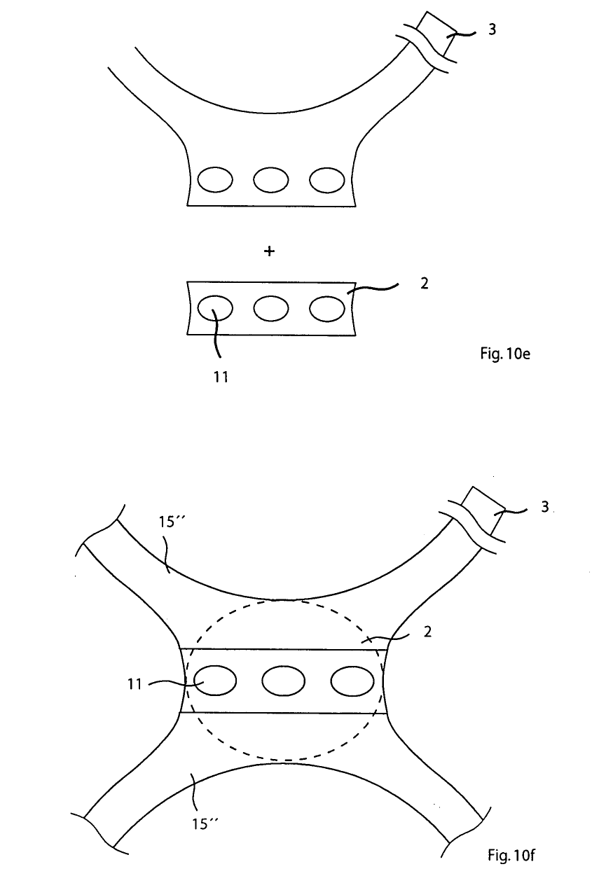

The attachment devices illustrated in FIGS. 10a to 10f consist of essentially three parts, with two identical blanks 15″ being joined with a central section 2. FIG. 10a shows an elliptical part that forms the central section 2 and a strap with two strap ends 3. Two of these straps are joined as identical parts 15″ with an elliptical part by snap fasteners 11. Since the parts 15″ are identical, they are suitable for placement on both the upper part and the lower part of the back of the head. Here again, the central section 2 is a preform.

The strap shown in FIG. 10c is a simple rectangular strip, which likewise has a snap fastener 11 for joining it with the central section 2, which in the present case is triangular and, in addition, has a central opening 6. The central opening 6 has the advantage of allowing good ventilation of the back of the head. Since snap fasteners consist of lower parts and upper parts, the rectangular strap can be provided with the lower parts of snap fasteners at intervals that can be flexibly used. Two straps or two parts 14′, 15′ can thus be joined with varying amounts of separation with a third part, which has a triangular central section 2 with an upper part of a snap fastener at each corner.

The attachment devices illustrated in FIG. 10f and FIG. 10e are similar in design. In this case, the central section 2 has a simple, rectangular geometry. The central section 2 has upper parts of snap fasteners 11 arranged at various intervals. Two identical supplementary parts 15″ with lower parts of snap fasteners 11 are joined with the central section 2 to form an attachment device. The broken-line circle indicates the actual central section 2.

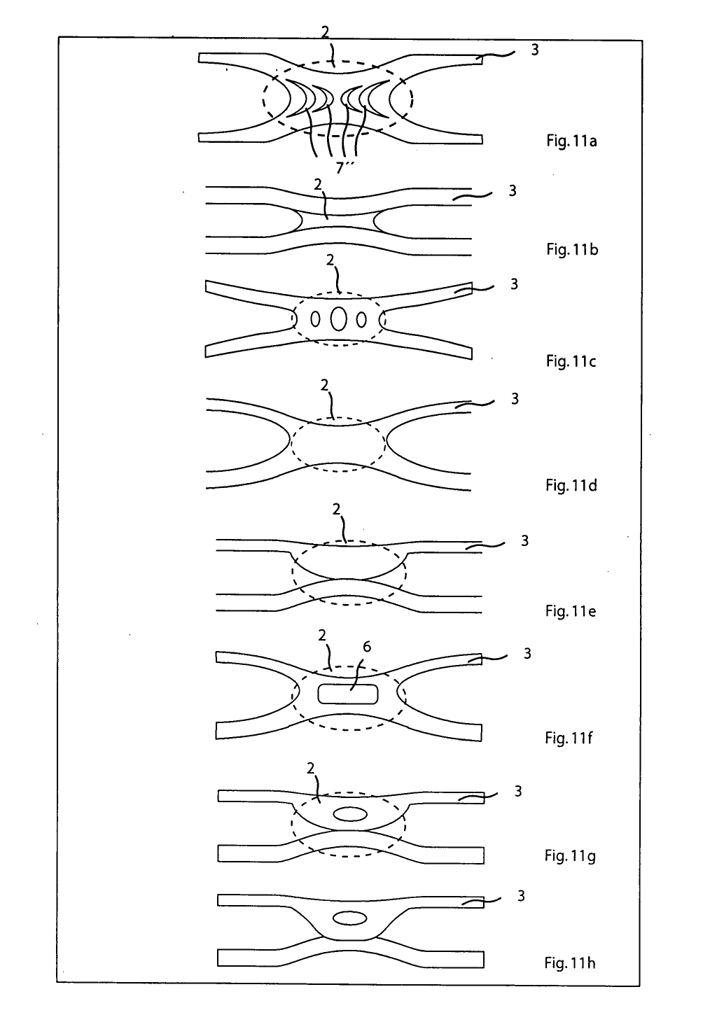

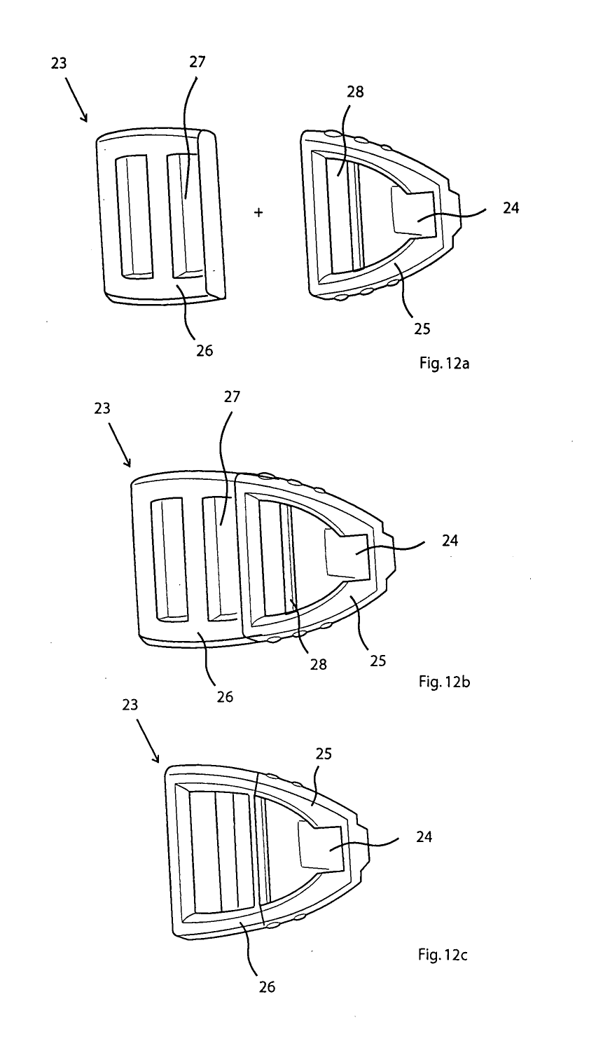

FIGS. 11a to 11h show attachment devices with four strap ends 3. The central sections 2, which are identified by broken lines, have a different design in each case. FIGS. 11a, 11c, 11e, 11g and 11h have openings 6, 7′ in the central section 2. According to the cut that is selected, the strap ends 3 of the different embodiments are arranged close to each other or are spaced farther apart, so that the wearer can select a suitable attachment device that optimally corresponds to the shape of his head.

In another advantageous embodiment, as shown in FIGS. 11c and 11e, the central sections 2 have openings 6 with specific geometric shapes, which can be used as tensile force indicators. To this end, as he is putting on the attachment device and the mask in front of a mirror, the wearer watches the geometrically simple opening 6 in the central section 2 and applies only as much tension while securing the mask as will not cause this geometric shape to be deformed. If too much tension is applied and thus deformation of the simple geometric shape is observed, the strap can be correspondingly loosened until the shape returns to its original state. This allows the mask to be put on without tension and thus without pain.

To join the attachment device with the ventilator mask, it is possible, for example, to provide the ends of the straps with a fastening device, as shown in FIGS. 12a to 12c, alternatively or additionally to the friction fasteners at the ends of the straps.

As an example, FIG. 12a shows a fastening device that consists of two parts 25, 26. The first part 25 has a latch 28 that engages a corresponding opening 27 provided in the second part 26. In the illustrated example, the part 26 has two openings 27, so that the fastening device can be flexibly varied in its length.

FIG. 12b shows a fastening device designed as a snap-in locking device 23, in which the latch 28 of the first part 25 has been engaged with the closer opening of the second part 26, so that the other openings 27 are available for passing the strap ends 3 through them.

FIG. 12c shows a fastening device with a design that is similar to but shorter than the design shown in FIG. 12b. In this fastening device, the latch 28 likewise engages the opening 27 that is closest to it. However, this leaves only one opening 27 for the strap end 3 to be passed through, so that the strap end 3 is closed with itself by a friction fastener. In FIG. 12b, the strap end, which is passed through two openings, can be secured in its position without the need for an additional friction fastener, since the securing of the strap end 3 passed through two openings 27 keeps the strap end reliably in place.

The projections 24 present in all of FIGS. 12a to 12c serve the purpose of engaging corresponding receiving devices present on the ventilator mask. Alternatively, the receiving device or receiving hole can be located on the fastening device, which is engaged by a locking projection present on the ventilator mask.

To achieve optimal adaptation of the geometry of the preformed central sections of the attachment devices in accordance with the invention to the head of the wearer, the geometry of the head can be determined, for example, by a scanning method, and then electronically stored and processed. The data obtained in this way can then be used to carry out the performing process. After performing processes, especially thermal processes, such as the well-known process of molding, have been completed, the molded part remains permanently three-dimensionally deformed. This results in a dimensionally stable attachment device that can withstand even frequent washing cycles. Well-known types of molding apparatus already provide for the recording and processing of the necessary data with respect to the shape to be molded; they are already well known to those skilled in the art.

While specific embodiments of the invention have been described in detail to illustrate the inventive principles, it will be understood that the invention may be embodied otherwise without departing from such principles.

I claim:

1. An attachment device for fastening a ventilator mask on the head of a wearer, the device comprising a system of straps with at least two strap ends, wherein the strap ends are one of releasably connectable with the ventilator mask and releasably connectable with the mask by at least one fastening device, wherein the straps are connected to a central section, wherein at least two strap ends extend away from the central section towards the ventilator mask, and wherein the central section is adapted to rest on the head of the wearer and is at least partially adapted to the shape of the wearer's head.

2. The attachment device in accordance with claim 1, wherein the central section is adapted to rest against the back of the wearer's head and is at least partially adapted to the shape of the back of the wearer's head.

3. The attachment device in accordance with claim 1, wherein the central section is adapted to rest against the wearer's chin and is at least partially adapted to the shape of the wearer's chin.

4. The attachment device in accordance with claim 1, wherein the central section is adapted three-dimensionally to the shape of the head.

5. The attachment device in accordance with claim 1, wherein the central section is a preform.

6. The attachment device in accordance with claim 5, wherein the shape of the preform is adapted essentially to the shape of the area of contact on the head.

7. The attachment device in accordance with claim 5, the preform is a textile preform produced from natural and/or synthetic fabric.

8. The attachment device in accordance with claim 1, wherein each strap end is joined with itself to form a loop.

9. The attachment device in accordance with claim 8, wherein one of
a friction fastener,
a snap fastener, and
a button-buttonhole combination
is used for releasably joining the strap end with itself.

10. The attachment device in accordance with claim 8, wherein the strap end is unreleasably joined with itself by a seam.

11. The attachment device in accordance with claim 1, wherein the at least two strap ends which extend towards the ventilator mask, have fastening devices for fastening the strap ends to the ventilator mask.

12. The attachment device in accordance with claim 11, wherein the fastening device has a snap-in locking device with at least one part and with at least one projection for engagement in a corresponding recess in the ventilator mask, which recess receives and secures the projection.

13. The attachment device in accordance with claim 11, wherein one of the parts of the fastening device has a recess for receiving and securing a locking projection present on the ventilator mask.

14. The attachment device in accordance with claim 12, wherein the two parts comprising
a first part has at least one latch and
a second part having at least one opening,
wherein the latch is suitable for releasable engagement in the opening.

15. The attachment device in accordance with claim 1, wherein the system of straps and the central section are produced from a single part.

16. The attachment device in accordance with claim 14, wherein the first part is a tubular section.

17. The attachment device in accordance with claim 1, wherein the system of straps and the central section are produced from at least two parts which are undetachably joined with each other, by one of sewing, welding, and adhesive bonding.

18. The attachment device in accordance with claim 1, wherein the system of straps and the central section are produced from at least two parts, wherein a first part is joined with a second part by at least one of:
a strap loop which is located on the first part, and at least one strap end which is located on the second part and is suited to being passed through the strap loop,
a friction fastener,
a lace and at least one eye,
a button and a buttonhole,
a snap fastener, and
a zipper.

19. The attachment device in accordance with claim 18, wherein the first part has several strap loops and the second part has an odd number of strap ends, so that for joining the first part with the second part, alternatively, an even number or an odd number of strap ends of the first part is passed through the one or more strap loops of the second part, and so that, alternatively, an even number or an odd number of strap ends is available for joining with the ventilator mask and for securing the ventilator mask.

20. The attachment device in accordance with claim 1, wherein the central section has at least one recess.

21. The attachment device in accordance with claim 20, wherein the recess has a basic geometric shape.

22. The attachment device in accordance with claim 21, wherein the basic geometric shape can be reversibly deformed by the application of a tensile force, with the deformation being a measure of the tensile force that is applied.

23. The attachment device in accordance with claim 1, wherein the device comprises an additional tensile force indicator arranged in its vicinity.

24. A method for producing an attachment device for fastening a ventilator mask on the head of a wearer, the device having a central section and a system of straps with at least two strap ends, wherein at least two of the strap ends extend away from the central section towards the ventilator mask, and wherein the system of straps is joined with the central section, which rests against the head of the wearer, the method comprising performing the central section such that it the central section at least partially adapted to the shape of the wearer's head.

25. The method in accordance with claim 24, comprising adapting the central section to the shape of the back of the wearer's head.

26. The method in accordance with claim 24, comprising adapting the central section to the shape of the wearer's chin.

27. The method in accordance with claim 24, wherein the performing is thermal performing and results in permanent performing of the central section.

28. The method in accordance with claim 24, wherein the attachment device is produced from a single part, the method comprising the steps of:
producing a tubular section the tubular section of textile material and of a size suitable for holding a head,
removing at least one recess from the tubular section, and leaving at least one web along a longitudinal axis of the tubular section and at least two webs along a transverse axis of the tubular section, and wherein the at least one longitudinal web connects the transverse webs, and
vertically cutting the transverse webs on their side facing the ventilator mask, so that each transverse web provides two strap ends.

29. The method in accordance with claim 24, comprising the steps of determining the size of a head by measuring the head manually, optically or electronically.
